(19) United States
(12) Patent Application Publication
(10) Pub. No.: US 2002/0172167 A1
(43) Pub. Date: Nov. 21, 2002

(54) Traffic control method of wireless mobile communication

(76) Inventors: Ki Seon Kim, Kwangju-si (KR); Seok Joo Shin, Kwangju-si (KR)

Correspondence Address: BIRCH STEWART KOLASCH & BIRCH, PO BOX 747, FALLS CHURCH, VA, 22040-0747, US

(21) Appl. No.: 09/882,035

(22) Filed: Jun. 18, 2001

(30) Foreign Application Priority Data
Apr. 18, 2001 (KR) 2001-20883

(51) Int. Cl. H04Q 7/00

(52) U.S. Cl. 370/329; 370/347

(57) ABSTRACT

The present invention discloses a traffic control method of a wireless mobile communication which can reduce interference of users and provide various services, by efficiently managing frequency resources in the wireless mobile communication. A reserve access channel for channel reservation is based on a spreading code method, and controlled in slot units for a voice traffic and a data traffic. In order to minimize an error due to interference of the simultaneous users in one slot, a reserve channel permission probability function is obtained from the previous frame information. Accordingly, the reserve access channel controlling of the present invention improves a transmission delay property for various information sources of voice, data and real time traffic.

### BACKGROUND OF THE INVENTION

1. Field of the Invention

The present invention relates to a traffic control method of a wireless mobile communication, and in particular to an improved traffic control method of a wireless mobile communication which is suitable to optimally utilize limited resources by controlling packet switching type channel access in order to efficiently provide various services for wireless communication or portable communication.

2. Description of the Related Art

Recently, practical medium access of a wireless mobile communication is packet transmission by random access which is one of the packet switching algorithms using advantages of time division multiple access and code division multiple access.

However, the random access accesses a slot in the same manner as slotted ALOHA, and thus has low link efficiency due to frequent packet collision of users.

As an advanced algorithm, a composite code division multiple access/packet reserve multiple access algorithm extracts a probability proportional to a number of terminals reserving slot access, and controls the slot access by using a channel access permission probability function.

The aforementioned algorithm has better performance than the random access, but increases a packet waste and decreases link efficiency due to packet collision. Basically, it is difficult to efficiently allocate resources to optimize the channel access permission probability function.

In order to reduce packet collision and improve link efficiency, there has been suggested a modified composite code division multiple access/packet reserve multiple access algorithm. Here, a reserve access channel for reserving a channel and traffic channels are individually used, and users are controlled according to a reserve channel access permission probability based on information of previous users attempting to access the channel.

As described above, the modified algorithm efficiently controls traffic channel access of the users through the reserve channel, thereby improving reliability in using the channel. In addition, the algorithm can reduce packet collision in the reserve channel according to the reserve channel permission probability function.

However, although a voice service achieves sufficient link efficiency, data terminals frequently employ the reserve access channel in a data traffic, thus causing collision of reserve packets in the reserve access channel. Such collision considerably increases a transmission delay time in the data traffic.

### SUMMARY OF THE INVENTION

It is, therefore, an object of the present invention to provide a traffic control method of a wireless mobile communication which can efficiently utilize resources, by operating a reserve access channel according to spread ALOHA based on a spreading code method, differently from a modified composite code division multiple access/packet reserve multiple access algorithm, by individually using the reserve access channel and traffic channels, and by restricting user interference by controlling transmission of reserve packets according to a reserve channel permission probability.

In one aspect of the present invention, one of a plurality of traffic channels is designated as a reserve access channel based on a spreading code method for reserving a channel, the channels are divided into a plurality of slots for packet transmission, and a voice traffic and a data traffic are respectively provided with the slots in the reserve access channel.

In addition, reserve packets transmitted from terminals to a base station through the slots are controlled according to a reserve channel permission probability obtained from number information of terminals attempting to access in a previous frame period in the base station.

To achieve the above object, there is provided a traffic control method of a wireless mobile communication including: a channel allocation step for allocating data transmission/reception channels to a reserve access channel based on a spreading code method for transmitting reserve packets for channel reservation and traffic channels for transmitting information packets; a channel division step for dividing the channels into a plurality of slots to control all packet transmission for data transmission/reception in slot units; and a data transmission step for controlling the data transmission according to a reserve channel permission probability transmitted from a plurality of terminals to a base station.

### BRIEF DESCRIPTION OF THE DRAWINGS

The above objects, features and advantages of the present invention will become more apparent from the following detailed description when taken in conjunction with the accompanying drawings, in which:

FIG. 1 is a schematic diagram illustrating a wireless mobile communication system in accordance with the present invention;

FIG. 2 is a structure diagram illustrating frames of a reserve access channel based on a spreading code method in accordance with the present invention; and

FIG. 3 is a graph showing transmission delay of a data traffic due to variations of a number of users.

### DETAILED DESCRIPTION OF THE PREFERRED EMBODIMENT

A preferred embodiment of the present invention will now be described with reference to the accompanying drawings. In the following description, same drawing reference numerals are used for the same elements even in different drawings. The matters defined in the description such as a detailed construction and elements of a circuit are nothing but the ones provided to assist in a comprehensive understanding of the invention. Thus, it is apparent that the present invention can be carried out without, those defined matters. Also, well-known functions or constructions are not described in detail since they would obscure the invention in unnecessary detail.

In accordance with the present invention, a reserve access channel based on a spreading code method for reserving a channel and traffic channels are individually used, the reserve access channel is controlled in slot units, and slots are allocated to voice terminals and data terminals, respectively.

In addition, a reserve channel permission probability is calculated according to number information of terminals attempting to access in a previous frame. The reserve packet transmission of each terminal is controlled according to the reserve channel permission probability and the reserve access channel based on the spreading code method.

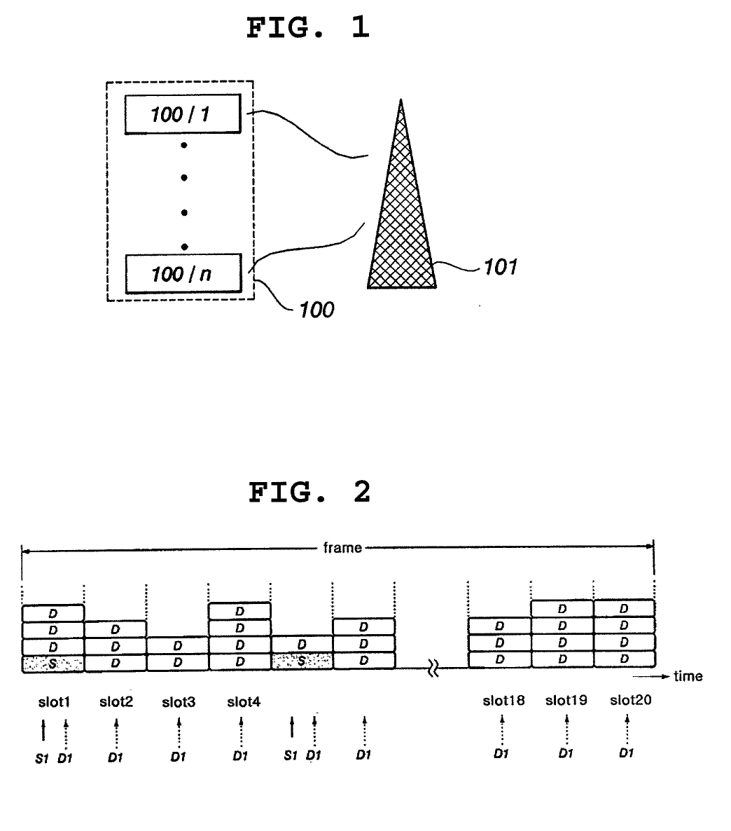

FIG. 1 is a schematic diagram illustrating a wireless mobile communication system in accordance with the present invention, and FIG. 2 is a structure diagram illustrating frames of the reserve access channel based on the spreading code method in accordance with the present invention. The wireless mobile communication system includes one cell environment having a plurality of wireless mobile terminals 100 and a base station 101.

The plurality of wireless mobile terminals 100 in one cell are terminals 100 for performing communication in a packet switching method, such as IMT-2000. Here, the wireless mobile terminals 100 inversely access the slots allocated to services of the reserve access channel based on the spreading code method, and transmit reserve packets D, S to the base station 101.

The base station 101 receiving the reserve packets D, S from the wireless mobile terminals 100 confirms whether the traffic channel is available, and transmits channel permission to each wireless mobile terminal 100 through a predetermined downward channel. The wireless mobile terminals 100 receiving the channel permission transmit information packets such as voice, data and image to the base station 101 through an inverse direction traffic channel. Here, the reserve packets D, S are optimally transmitted from the wireless mobile terminals 100 to the base station 101 according to a reserve channel permission probability function from the base station 101.

In general, the base station 101 sets up communication services of the wireless mobile terminals 100 in the service region, such as general call setup and cancellation, location registration and cancellation, condition checkup, hand-off processing, and call setup and cancellation for additional information services.

In addition, when receiving the reserve packets D, S from the wireless mobile terminals 100 through the reserve access channel based on the spreading code method, the base station 101 transmits a PN code for transmitting information packets and slot information to the wireless mobile terminal 100 successfully reserving the channel.

In principle, the traffic control method of the wireless mobile communication introduces code division multiple access, and thus a number of available channels for minimizing an error due to interference is determined according to a spreading factor. When the number of the channels is decided, one channel is designated as the reserve access channel based on the spreading code method, and the other channels are used as the traffic channels for transmitting information packets.

A time axis of the traffic channels and the reserve access channel consists of a plurality of frames, and the respective frames are divided into a plurality of slots.

In addition, a frame transmission rate is dependent upon a packet access rate of the voice traffic. When one packet is transmitted in one frame, the voice traffic satisfies the given transmission rate. Here, a number of slots per one frame and a number of bits per slot are decided in transmission of the voice traffic.

The traffic channel used to transmit the information packet is controlled by the base station 101, thus preventing collision of the packets. Moreover, the reserve access channel based on the spreading code method for transmitting the reserve packets D, S is accessed according to the spread ALOHA, thus preventing collision of the reserve packets D, S.

However, the spread ALOHA introduces a spectrum spreading property of code division multiple access (CDMA). Accordingly, when a plurality of users transmit the reserve packets D, S in one slot at the same time, a packet error may be generated due to increase of interference.

In order to minimize the packet error in the reserve access channel based on the spreading code method, the base station 101 calculates a reserve channel permission function, and transmits the resultant value to the respective wireless mobile terminals 100 in a broadcasting type.

Referring to FIG. 2, twenty slots are allocated to the respective frames of the reserve access channel. Here, the voice terminals 100 can transmit the reserve packets D, S in every fourth slot S1, but the data terminals 100 can transmit the reserve packets D, S in all slots D1. In addition, a plurality of users can simultaneously transmit the reserve packets D, S in each slot, without causing collision.

In the aforementioned frame structure, when the traffic channel does not have an available slot and when an error of the reserve packets D, S occurs due to increase of the interference in the slot of the reserve access channel based on the spreading coding method, the random wireless mobile terminal 100 having the information packet to be transmitted cannot reserve the slot of the traffic channel.

When the traffic channel has the available slot, the base station 101 transmits the PN code and the slot information to the wireless mobile terminal 100 successfully reserving the slot. The wireless mobile terminal 100 which fails to reserve the slot due to the above-described reasons must re-transmit the reserve packets D, S. At this time, a number of the wireless mobile terminals 100 accessing the reserve channel should be restricted to minimize the error of the reserve packets D, S.

In order to control the number of the wireless mobile terminals 100, the base station 101 calculates a reserve channel permission probability, and then controls transmission of the reserve packets D, S of the wireless mobile terminals 100 according to the calculated probability.

That is, the base station 101 controls the wireless mobile terminal 100 decided by the reserve channel permission probability to re-transmit the reserve packets D, S in the succeeding slot, thereby minimizing the error of the reserve packets D, S due to interference in the reserve access channel.

The reserve channel permission probability function is varied according to time. So as to calculate a presumed value of the number of the terminals 100 transmitting the reserve packets D, S in the current frame, a number of the terminals 100 transmitting the reserve packets D, S in the previous frame is calculated, and the resultant values of a few frames are averaged, thereby statistically calculating the reserve channel permission probability.

Firstly, when it is presumed that a number of users accessible to the voice traffic in one frame period is ‘Nᵥ’, and that a number of users accessible to the data is ‘N_{d}’, ‘Nᵥ’ and ‘N_{d}’ are represented by the following formulae:

Nᵥ=Nₛᵥ <Formula 1>

N_{d}=N_{sd}×Uₛᵢ <Formula 2>

wherein, ‘Nₛᵥ’ denotes a number of slots for the voice terminal 100, ‘N_{sd}’ denotes a number of slots for the data terminal 100, and ‘Uₛᵢ’ implies a maximum number of simultaneous accessible users in one slot without causing an error due to interference.

In addition, an average ‘Kₚᵣₑ’ of the numbers of the terminals 100 attempting to access the reserve access channel in the previous frames is represented by the following Formula:

$${K}_{pre} = \frac{1}{n} {\sum }_{i = 1}^{n} {T}_{i} \qquad \text{<Formula 3>}$$

wherein, ‘n’ denotes a number of the previous frames used to calculate ‘Kₚᵣₑ’, and ‘Tᵢ’ denotes a number of the terminals 100 attempting to access the reserve access channel in the previous i-th frame.

Accordingly, when it is presumed that a reserve channel permission probability of the voice traffic is ‘Pᵥ’ and that a reserve channel permission probability of the data traffic is ‘P_{d}’, ‘Pᵥ’ and ‘P_{d}’ are represented by following Formulae 4 and 5, referring to Formulae 1 to 3:

$$\begin{matrix}{P}_{v} = ( \begin{matrix}1 & {K}_{pre} ⟨ {N}_{v} \\ \frac{{N}_{v}}{{K}_{pre}} & {K}_{pre} ⟩ {N}_{v}\end{matrix} ) & \text{<Formula 4>} \\ {P}_{pd} = ( \begin{matrix}1 & {K}_{pre} < {N}_{d} \\ \frac{{N}_{d}}{{K}_{pre}} & {K}_{pre} > {N}_{d}\end{matrix} ) & \text{<Formula 5>}\end{matrix}$$

The base station 101 transmits ‘Kₚᵣₑ’ to all the wireless mobile terminals 100 in an initial point of the frames, so that the terminals 100 can use Formulae 4 and 5.

Moreover, when the terminal 100 fails to reserve the channel for a specially-defined maximum voice delay time in transmitting the voice packet S, the packet S is wasted according to a voice real time service property.

Here, the voice terminal 100 consecutively transmits one packet in one frame by one reservation for a voice active period, which is deemed to be a periodical data. In the transmission of the data terminal packet D requiring packet reservation, when the data terminal 100 fails to reserve the slot, the data packet D is stored in a buffer because it is not sensitive to time delay.

When at least one data packet D is stored in the buffer, if the reservation is made, the data packet D is transmitted as a periodical data until the buffer is empty, which reduces channel load due to the data traffic. In addition, a plurality of packets can be transmitted by one channel access, thereby reducing a delay time of information packets.

The data terminal 100 randomly generates packets and frequently accesses the reserve access channel. In accordance with the present invention, the twenty slots set up in the reserve access channel based on the spreading code method are allocated to the data terminal 100.

Especially, the five slots are shared in the data and voice services, but the fifteen slots are used merely for the data service.

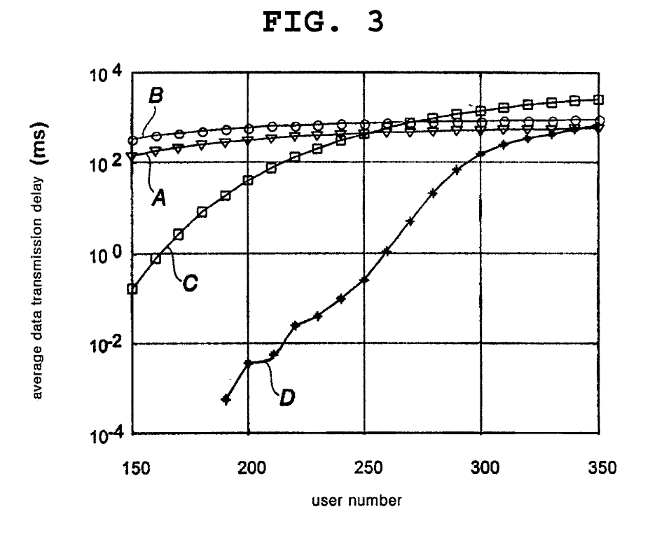

In the case that the conventional modified composite code division multiple access/packet reserve multiple access algorithm is compared with the traffic control method of the present invention in an isolated cell environment in respect of a packet waste due to variations of a number of simultaneous users and a transmission delay time of the data service, the experiment result of the voice service shows an almost identical packet waste, but the experiment result of the data service is shown in FIG. 3.

The circle-shaped graph (B) and the inverted triangle-shaped graph (A) show the transmission delay property of the data traffic due to variations of the number of the simultaneous users in the conventional modified composite code division multiple access/packet reserve multiple access algorithm, and the lozenge-shaped graph (C) and the star-shaped graph (D) show the transmission delay property of the data traffic due to variations of the number of the simultaneous users in the traffic control method of the present invention.

In addition, the circle-shaped graph (B) and the lozenge-shaped graph (C) do not have the reserve channel permission probability function, but the other two graphs (A, D) have the reserve channel permission probability function (n=1).

Referring to FIG. 3, the traffic control method does not cause packet collision in the reserve access channel based on the spreading code method, the transmission delay is generated by re-transmission by the reserve packet error due to interference of the excessive simultaneous users or re-transmission delay due to over-capacity of the traffic channel.

Therefore, the traffic control method of the wireless mobile communication has a much lower transmission delay time than the conventional method, especially when the number of the users is small. In addition, it has an improved transmission delay property by using the reserve channel permission probability function.

In accordance with the present invention, the traffic control method of the wireless mobile communication individually use the reserve access channel based on the spreading code method and the traffic channels, controls the channel in slot units, and also controls reserve packet transmission of the terminals according to the reserve channel permission probability calculated by the number of the accessible users in one frame for the voice terminal, the number of the users for the data terminal, and the number information of the terminals attempting to access in the previous frame. It is thus possible to efficiently utilize limited frequency resources by restricting interference between the users.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A traffic control method of a wireless mobile communication, comprising:
a channel allocation step for allocating data transmission/reception channels to a reserve access channel based on a spreading code method for transmitting reserve packets for channel reservation and traffic channels for transmitting information packets;
a channel division step for dividing the channels into a plurality of slots to control all packet transmission for data transmission/reception in slot units; and
a data transmission step for controlling the data transmission according to a reserve channel permission probability transmitted from a plurality of terminals to a base station.

2. The method of claim 1, wherein the data transmission step further comprises a transmission permission step for transmitting a PN code for transmitting the information packet and slot information to the corresponding terminal, when the base station receives the reserve channel from the terminal.

3. The method of claim 1, wherein the respective users transmit their reserve packets in one slot according to the spread ALOHA in the reserve access channel based on the spreading code method.

4. The method of claim 1, wherein the reserve channel permission probability is calculated according to a number of accessible users in one frame for transmission of a voice terminal, a number of accessible users for transmission of a data terminal, and an average of number information of terminals attempting to access in the previous frames.

5. The method of claim 4, wherein the number of the users accessible to the voice traffic in one frame period is identical to the number of the slots for the voice terminal.

6. The method of claim 4, wherein the number of the users accessible to the data is calculated by multiplying the number of the slots for the data terminal by the maximum number of the simultaneous accessible users in one slot without causing an error due to interference.

7. The method of claim 4, wherein an average Kₚᵣₑ of numbers of the terminals attempting to access the reserve access channel based on the spreading code method in the previous frames is represented by the following formula (‘n’ denotes a number of the previous frames used to calculate Kₚᵣₑ, and Tᵢ denotes a number of the terminals attempting to access the reserve access channel in the previous i-th frame):
$${K}_{pre} = \frac{1}{n} {\sum }_{i = 1}^{n} {T}_{i} .$$

8. The method of claim 4, wherein a reserve channel permission probability of the voice terminal and a reserve channel permission probability of the data terminal are used as the reserve channel permission probability.
